(19) United States
(12) Patent Application Publication
(10) Pub. No.: US 2004/0097229 A1
(43) Pub. Date: May 20, 2004

(54) Provision of services in a communication system

(76) Inventors: Janne Muhonen, Helsinki (FI); Juhani Murto, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/470,092

(22) PCT Filed: Jan. 30, 2002
(86) PCT No.: PCT/EP02/01037

(30) Foreign Application Priority Data
Jan. 30, 2001 (GB) 0102361.3

(51) Int. Cl. H04Q 7/20

(52) U.S. Cl. 455/435.1; 455/422.1; 455/456.1; 455/404.2; 455/433

(57) ABSTRACT

A method for use in a communication system and a communication system are disclosed. A communication service is provided for a station (7). Information associated with the geographical location of the station (7) is also provided by a location information service (12). At least one condition can be set for the use of the communication service based on said information.

### FIELD OF THE INVENTION

The present invention relates to provision of services in a communication system, and in particular, but not exclusively, to provision of different service conditions for a station.

### BACKGROUND OF THE INVENTION

A communication system typically operates in accordance with a given standard or specification which sets out what the various elements of the system are permitted to do and how that should be achieved, i.e. the technology on which the communication is based on. A communication system may comprise one or more communication networks.

A communication network is a cellular network adapted to provide wireless communication services for the users thereof. A cellular system consists of access entities typically referred to as cells, hence the name cellular system. A feature of the cellular system is that it provides mobility for the mobile stations subscribing thereto. That is, the mobile stations are enabled to move within the cell and from a cell to another cell and even from a cellular network to another cellular network if both of the networks are compatible with the technical specification and/or standards the mobile station is adapted to.

Examples of the different cellular standards and/or specifications include, without limiting to these, standards such as GSM (Global System for Mobile communications) or various GSM based systems (such as GPRS: General Packet Radio Service), EDGE (Enhanced Data rate for GSM Evolution) or CDMA or WCDMA (Code Division Multiple Access or Wideband CDMA) based 3^{rd} generation telecommunication systems such as the Universal Mobile Telecommunication System (UMTS), i-Phone, IS-95 and IMT 2000 (International Mobile Telecommunication System 2000) and so on. It shall be appreciated that the terminology used in association with different elements of the communication systems may vary between the standards.

As mentioned above, an access entity may be formed by a cell. The cell can be defined as a certain area covered by at least one base transceiver station (BTS) serving mobile station (MS) or similar user equipment (UE) that is located within the cell coverage area. It should be appreciated that the size and shape of a cell depends on the system and circumstances.

The communication between a user equipment (UE) within one of the access entities (such as the cells or other service areas) of the communication system and a base station is typically controlled by one or several control functions. Examples of controller nodes providing the control functions include, without limiting to these, access network controllers such as a base station controller (BSC) or radio network controller (RNC) and core network entities such as a mobile switching centre (MSC) or serving GPRS support node (SGSN).

A service feature that can be provided by the cellular networks is the so called ‘home zone’ service. This service is known by the skilled person. The term home zone refers to a certain zone i.e. area in which a mobile station may receive specific service conditions. A home zone can be defined, for example, as a radio coverage area around the office or home of a subscriber.

The conditions on which the communication service is provided for the mobile subscriber may vary e.g. such that the mobile subscriber may be charged a different tariff depending whether the mobile station is located within the home zone or not. For example, the subscriber may be allowed to have cheaper calls whenever the mobile station is within the home zone.

Thus the home zone type services need to know the location of the mobile station in order to be able to decide whether the mobile station is located within its home zone or not. In the current home zone type applications the location of the mobile station is estimated based on information of the serving cell identity (serving cell ID) and/or cell identities of the cells that are in the neighbourhood of the serving cell at the time of establishing the communications connection. That is, the home zone is associated with one or more cells of the communication system and the borders of the home zone area follow the borders of the cell.

However, the accuracy that can be obtained based on the cell areas may not be good enough in all circumstances. Depending on how the radio network has been planned a cell may cover fairly large geographical area. Furthermore, the shape of a cell or a combination of cells may not always be optimal to form a desired home zone area. The home zone area may need to be provided by several cells so as to provide a home zone that covers an area with the desired shape and size. This may lead into a home zone area that is unnecessarily wide. For example, a substantially large cell coverage area by several cells may be needed to cover e.g. a corner of a building. In addition, the radio propagation conditions may change within a cell, either permanently or temporarily. This may cause unwanted variation in the size and shape of the home zone. The cell nomination scheme for a home zone may need to be updated from time to time in order to address the variation in the size and shape of the cells.

### SUMMARY OF THE INVENTION

Embodiments of the present invention aim to address one or several of the above problems.

According to one aspect of the present invention, there is provided a method in a communication system, comprising: initiating provision of a communication service for a station; providing information associated with the geographical location of the station by a location information service; and setting at least one condition for the communication service based on said information.

According to another aspect of the present invention there is provided a communication system, comprising: controller means for controlling provision of communication services for a station; location information service adapted to provide information associated with the geographical location of the station; and service controller means for controlling the provision of said communication service based on said information.

According to still another aspect of the present invention, there is provided a service controller for a communication system, comprising means for setting conditions for the use of a communication service that is provided for a station of the communication system, wherein the conditions are set based on information associated with the geographical location of the station, said information being provided by a location information service.

The embodiments of the invention may be used when determining whether a mobile station is located within a defined area or not. The accuracy of the such determinations may be improved. The defined areas such as the home zones do not need to depend on the cell structure and arrangement of the communication system. The embodiments may provide defined area arrangements that are not especially sensitive for the changes in the size and/or shape of the cells of a cellular communication system. Some of the embodiments may be used to prevent of abuse of the home zone type services. However, despite the improved accuracy of the location estimate call set up times are not necessarily increased.

### BRIEF DESCRIPTION OF DRAWINGS

For better understanding of the present invention, reference will now be made by way of example to the accompanying drawings in which:

FIG. 1 shows a part of a communication system in which the present invention may be employed;

FIG. 2 described the basic principles of an embodiment;

FIG. 3 message sequence during a call set-up in accordance with an embodiment;

FIG. 4 message sequence during an active call in accordance with an embodiment; and

FIG. 5 is a schematic example of further possibilities to define service areas by means of the invention.

### DESCRIPTION OF PREFERRED EMBODIMENTS OF THE INVENTION

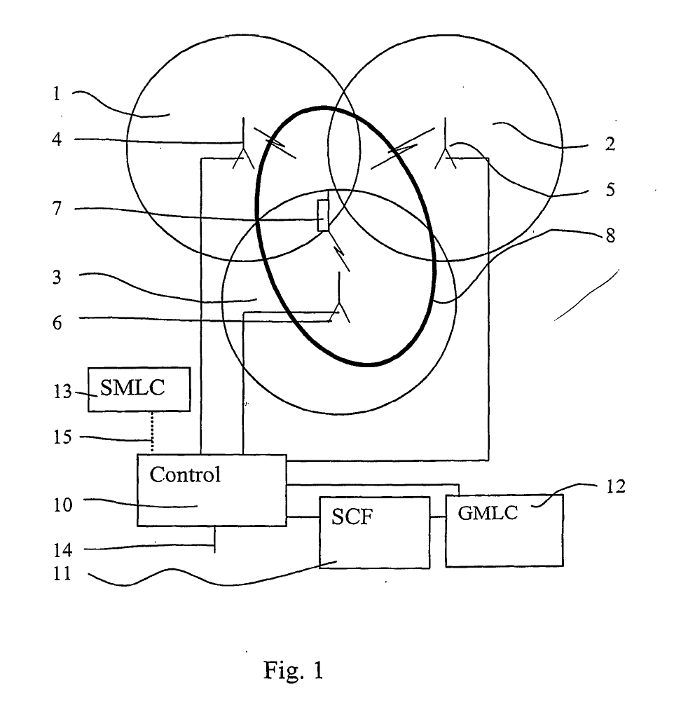

Before explaining the preferred embodiment of the invention in more detail, a reference is made to FIG. 1 which is a simplified presentation of some of the components of a cellular system. More particularly, FIG. 1 shows an arrangement in which three radio coverage areas or cells 1, 2 and 3 of a cellular telecommunications network is provided.

More particularly, each of the radio coverage areas 1, 2 and 3 is provided by a respective base station 4, 5 and 6. Each base station 4 to 6 is arranged to transmit signals to and receive signals from the mobile user equipment (UE) i.e. mobile station (MS) 7 via wireless communication. Likewise, the mobile station 7 is able to transmit signals to and receive signals from the base stations. It shall be appreciated that a number of mobile stations may be in communication with each base station although only one mobile station 7 is shown in FIG. 1 for clarity.

It shall also be appreciated that the presentation is highly schematic. The shape and size of the cells may be different from the illustrated substantially omnidirectional shape and uniform size. The size and shape of the cells may also vary from cell to cell. One cell may include more than one base station site. A base station apparatus or site may also provide more than one cell. These features of a cell depend on the implementation and circumstances.

Each of the base stations 4 to 6 is connected to a controller function 10. The controller function may be provided by any appropriate controller. It shall also be appreciated that the name, location and number of controller entities depends on the system. For example, a UMTS terrestrial radio access network (UTRAN) may employ a controller node that is referred to as a radio network controller (RNC). In the GSM a corresponding radio network controller entity is referred to a base station controller (BSC). The core network of both of the above mentioned systems may be provided with controller entities referred to as a mobile switching centre (MSC).

It is also noted that typically more than one controller is provided in a cellular network. The controller function 10 may be connected to other appropriate elements, such as to another mobile switching centre (MSC) and/or a serving general packet radio service support node (SGSN), via a suitable interface arrangement 14. However, the various other possible controllers are omitted from FIG. 1 for clarity reasons.

The cellular systems provide mobility for the users thereof. In other words, the mobile station 7 is able to move from one cell coverage area to another cell coverage area. The location of the mobile station 7 may thus vary in time as the mobile station is free to move from one location (base station coverage area or cell) to another location (to another cell) and also within one cell.

In the prior art solutions one or several of the cells could be selected to form a home zone for the mobile station 7. For example, cells 1 to 3 of FIG. 1 could be defined to form a home zone for the mobile station 7. However, the inventors have found that the cell based home zone arrangement have several disadvantages as discussed above.

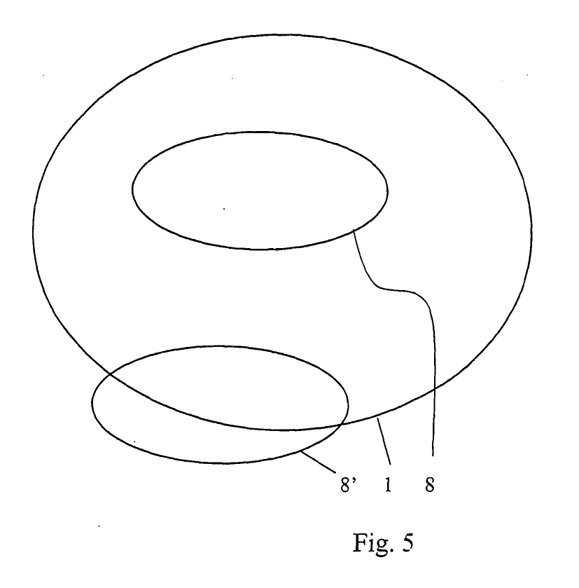

The inventors have found that these can be overcome if a defined area such as a home zone area 8 is defined independently from the cell coverage areas and/or radio access network apparatus. That is, the defined areas 8 for the home zone service may be defined such that the service area has a shape and coverage area that may be substantially different from that of the cells 1 to 3. In FIG. 1 the home zone is defined to cover only a portion of the cell coverage areas 1 to 3. However, it shall be appreciated that the defined area may also cover only a substantially small portion of a single cell coverage area (see e.g. FIG. 5).

The inventors have found further that a home zone type service can be implemented based on geographical location information regarding the location of the mobile station. The geographical location information is preferably determined and provided by a location information service.

The determined geographical location of the mobile station is compared to the area of the home zone 8. In practice this means that the home zone area 8 and the cell areas 1 to 3 are no longer linked to each other. This makes it easier to define home zone areas that more precisely correspond the needs of the mobile user and/or suit better for the network operator. Thus the home zone do not need to depend on the cell coverage areas but may be defined more freely based on the needs of the mobile users and/or the operators.

This can be accomplished by a solution in which the home zone type services are adapted to interwork with a location service associated with the communication system. Thus the communication system is shown to comprise means for providing a location service. More particularly, FIG. 1 shows a location services (LCS) node 12 providing location services for different applications or clients. In general terms, a location services node can be defined as an entity capable of providing information concerning the geographical location of a mobile station. There are different ways to implement the location services node, and the following will discuss an example that employs the so called gateway mobile location center (GMLC).

More particularly, in FIG. 1 the location service node 12 is shown to comprise a gateway mobile location center (GMLC) 12 that is arranged to receive via appropriate interface means predefined information concerning the mobile station and the location of the mobile station 7 from the cellular system. In addition to the information associated with the geographical location the information provided for the node 12 may include the identity (such as an international mobile subscriber identifier: IMSI) or a MSIDSN (a mobile subscriber integrated digital services number) or a temporary identifier of the mobile station 7.

The information may be provided by means of serving mobile location centre (SMLC) 13. The location service node 13 in an entity that is adapted to process location measurement data in order to determine the geographical location of the mobile station. The Location measurement data may be provided by means of one or several location measurement units (not shown). Node 13 is adapted to processes this information and/or some other predefined parameters and/or and to compute appropriate calculations for determining and outputting information associated with the geographical location of the given mobile station 7.

The serving location service node 13 may be implemented in the radio access network or the core network. If the serving location service node is implemented in the radio access network it may be in direct communication 15 with the access network controller function 10. In some applications the node 13 may be a part of the access network controller function. If the serving location service node is implemented in the core network it may then be arranged to receive the location measurement data from the radio network e.g. via the access network control function 10. The way how the location service architecture is arranged is an implementation issue, and will thus not be explained in more detail.

The geographical location may be defined on the basis of the position of the mobile station relative to the base station(s), location measurement units or similar elements implemented in the cellular network. The geographical location of a mobile station may be defined, for example, in geographical co-ordinates (latitudes and longitudes) or in X and Y co-ordinates. A possibility is to use the relation between defined radii and angles, e.g. based on the spherical coordinate system or alike. It is also possible to define the location of a mobile station in vertical directions. For example, altitude or Z co-ordinate may be used when providing the location information in the vertical direction. The vertical location may be needed e.g. in mountainous environments or in tall buildings.

The basic information for the location service may be obtained by using one or more of the appropriate location determination techniques. These are also known and will thus not be discussed in any great detail herein. The examples of the possible location determination methods include techniques that are based on use of the E-OTD (enhanced Observed time difference), time of arrival (ToA), time difference of arrival (TDoA), the signal Round Trip Time (RTT), cell id and timing advance (TA) information, signal strength measurements; and so on. The geographical location information may also be based on use of information provided by a location information services system that is independent from the communication system. Examples of these include the Global Positioning System (GPS), Assisted GPS (A-GPS) or the Differential GPS (D-GPS).

The information from the location measurement means is processed in a predefined manner and may then be provided to appropriate clients. In the described embodiment the client consists of a control entity 11. The operation thereof will be explained in more detail later in this specification.

The GMLC server node 12 may consists of a number of location service components and bearers needed to serve the clients. These are known and are thus not discussed in more detail. It is sufficient to note that the server node 12 may provide a platform which will enable the support of location based services in parallel with other communication services such as speech, data, messaging, other teleservices, user applications and supplementary services. The server node 12 may respond to a location request from a properly authorised client with location information for the target mobile stations specified by the client if considerations of target mobile station privacy are satisfied. The server node 12 may thus provide the client, on request or periodically, the current or most recent geographic location (if available) of the target mobile station or, if the location fails, an error indication and optionally the reason for the failure. A more detailed description of a LCS node that may be employed in the embodiments of can be found e.g. from ETSI (European telecommunications Standards Institute) technical specification No. 3GPP TS23.171 “Location Services” release 99 and GSM specification No. 03.71 “Location service, stage 2”.

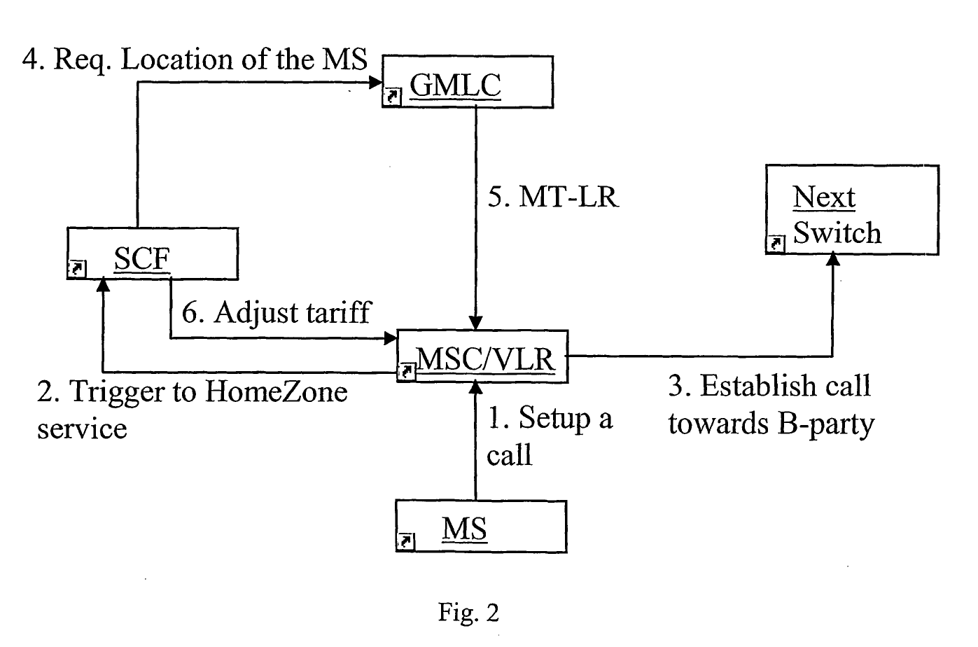

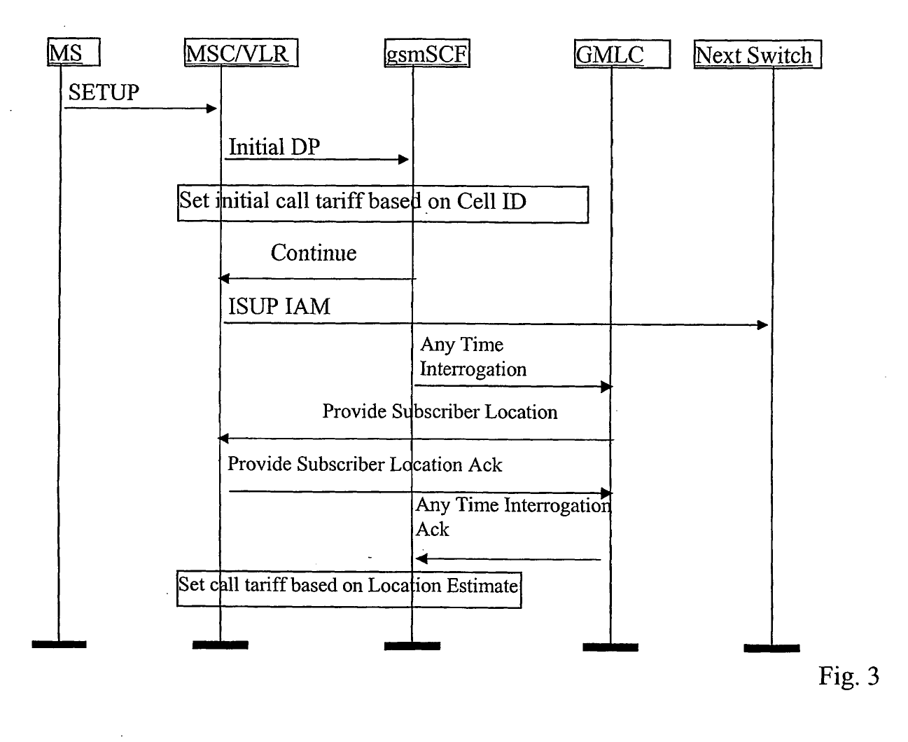

FIG. 2 exemplifies the basic principles of an embodiment of the proposed solution during session set up procedures. The signalling flowchart of FIG. 3 illustrates in more detail a possible order of the different messages during the call establishment procedures.

A mobile station (MS) initiates a session set up procedure for a mobile station originated communication towards a B-party. The B-party may be a second station or e.g. a server in the communication network. The B-party may be a fixed line terminal or another mobile station. The session set-up request is typically directed to the controller serving the base station with which the mobile station communicates with.

The mobile station 7 may be a subscriber of intelligent network (IN) services. For example, the user of the mobile station 7 may have subscribed services based on an IN/CAMEL mechanism. CAMEL is an abbreviation from ‘customised applications for mobile network enhanced logic’. The CAMEL service environment (CSE) provides the execution environment within a CAMEL SCP executing a service logic (The SCP stands for ‘service control point’ of the Intelligent Network). In the drawings the SCP can be provided by means of the service control function (SCF) 11.

The call is triggered during the call establishment procedures from the control entity 10 to the service control function 11. At the same time an initial characteristics of the session (e.g. the call tariff) may be set based on information of the serving cell ID in order to make a rough initial estimate whether the mobile station and thus the subscriber is within his home area or not. The session establishment procedure is continued at the same time or immediately after the message has been communicated to the service control function 11 in order to avoid any delays in the session set-up.

The service control function SCF 11 requests information regarding the location of the mobile station from the location service gateway node 12. The request may be made based on any location information request mechanism. The request may be based e.g. on the so called ‘Any Time Interrogation’ procedure that is defined in more detail e.g. in the 3GPP specification No. 23.078 and titled ‘Customised Applications for Mobile network Enhanced Logic (CAMEL) Phase 2’.

The gateway node 12 may then perform a standard location request procedure. An example of such is the MT-LR (Mobile terminated—location request) procedure that is described in detail e.g. in the above referred specification No. TS 03.71.

As a result of the steps 4 and 5 of FIG. 2 the service control entity 11 receives a location estimate regarding the geographical location of the calling mobile station. Based on the location estimate the service control entity 11 is able to more precisely estimate whether the subscriber is located within the home area or not. The service control entity may then adjust call tariff or any other condition for the communication service if it decides that this is needed.

The above describes an embodiment in which the price for the use of the communication service is controlled based on the information from the location service. It shall be appreciated that the condition of other service features of the communication service may also be made dependent of the location of the subscriber relative to a defined area such as the home zone. For example, the mobile subscriber may receive different quality of service (QoS) depending whether he/she is located within the home zone or not. Service restrictions may apply if a subscriber is not within (or alternatively is within) a defined area.

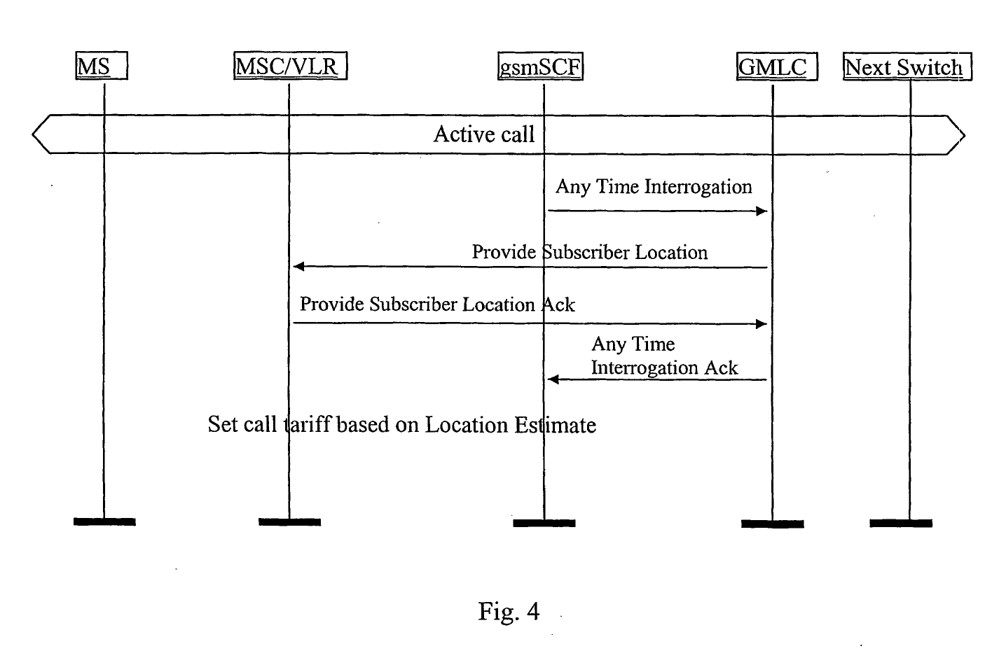

FIG. 4 signalling chart illustrates a way to use the proposed mechanism for changing call tariff or any other condition during an active session. This feature may be used e.g. in order to avoid abuse of the service or to take the actual location of the mobile user better into account. The change of the tariff may be required, for example, when a call is established when the mobile station was within the home zone area and has since moved outside the home area during the call. The first part of the call can be charged based on the home zone tariff. The part of the call that is made outside the home zone may be charged based on another tariff.

The frequency how often positioning is done during an active call may be adjustable. It is possible that the service control function 11 periodically request the location information every time after a predefined time has lapsed from the latest provision of the information. The IN based embodiments may be implemented e.g. so that the CAMEL SCP periodically asks the location of the subscribers belonging to the list from the GMLC 12. The periodical check may also be accomplished such that the location service 12 “pushes” the location information to the control function 11 with predefined intervals.

In FIG. 1 the defined area 8 is shown to extend over three different cells 1 to 3. FIG. 5 shows a situation where the defined area 8 extends only over a portion of the cell 1. FIG. 5 shows also another substantially small defined area 8′ that covers a small portion of the cell 1 and a neighbouring cell (not shown).

It should be appreciated that whilst embodiments of the present invention have been described in relation to mobile stations, embodiments of the present invention are applicable to any other suitable type of user equipment.

It shall also be appreciated that while the above discusses a solution for enhancing home zone services in association with IN and/or CAMEL-services, the invention is not limited to use with the services. It is, for example, possible to implement the embodiments in an all IP (internet protocol) systems based on an appropriate server function. The server function be based on use of the session initiation protocol (SIP).

It shall also be appreciated that while the embodiment have been discussed in the above with reference to home zone type services, the embodiments are by no means restricted to this. The embodiments may be used to enhance home zone type services in any communication standard.

It should also be appreciated that the elements of the location service functionality may be implemented anywhere in the telecommunications system. The location service implementation may also be distributed between several elements of the system. At least a part of the location service nodes may also be an external to the cellular system. According to an embodiment the mobile station or user equipment provides the location service node. The mobile station may be provided with the location service processing function and may be capable of generating and transporting location information thereof to the clients. The mobile station 7 may be provided with terminal equipment apparatus (either integrated in the mobile station device or connected thereto).

For clarity reasons this specification uses the term base stations for all kinds of stations that are capable of transmitting signals towards and/or receiving signals from a mobile user equipment. It should also be appreciated that in some systems, such as in the systems providing 3^{rd} generation telecommunication services, the base station may be referred to as Node B.

An advantage of the solution is that the home zone area 8 can be defined more accurately. The area does not depend on the cell structure and form. It is easier to take action against abuse of the home zone service since the calls that are established in the home area can be charged with higher rate immediately or fairly soon after the mobile station has moved out from the area during the call. Even though more accurate estimate of the location or the mobile station is obtained the call set-up time is not necessarily increased.

It is also noted herein that while the above describes exemplifying embodiments of the invention, there are several variations and modifications which may be made to the disclosed solution without departing from the scope of the present invention as defined in the appended claims.

1. A method in a communication system, comprising:
initiating provision of a communication service for a station;
providing information associated with the geographical location of the station by a location information service; and
setting at least one condition for the communication service based on said information.

2. A method as claimed in claim 1, wherein the at least one condition is set in response to determination whether the station is located within a defined geographical area or not.

3. A method as claimed in claim 1 or 2, wherein the station is provided with a home zone service.

4. A method as claimed in any preceding claim, wherein the geographical location information comprises location co-ordinates of the station.

5. A method as claimed in claim 4, wherein the location co-ordinates comprises geographical co-ordinates.

6. A method as claimed in claim 4, wherein the location co-ordinates comprises co-ordinates of a predefined co-ordinate system.

7. A method as claimed in any preceding claims, wherein the setting of conditions is accomplished substantially at the same time with a procedure for establishing a communication connection for the station.

8. A method as claimed in any preceding claims, wherein the setting of conditions is accomplished during an established communication connection.

9. A method as claimed in any preceding claim, comprising the step of requesting for information associated with the geographical location of the station from the location information service.

10. A method as claimed in any preceding claim, wherein the conditions are set by a service control function of the communication system.

11. A method as claimed in claim 10, wherein the service control function requests for said information associated with the geographical location of the station.

12. A method as claimed in claim 11, wherein the location information is requested during the communication establishment procedures.

13. A method as claimed in any of claims 9, 11 or 12, wherein the location information is requested periodically during the use of the communication service.

14. A method as claimed in any preceding claim, wherein the location information service provides said information without a request to do so.

15. A method as claimed in any preceding claim, wherein the location information service is provided by the communication system.

16. A method as claimed in any preceding claim, wherein information associated with the geographical location of the station is determined by an element associated with the communication system.

17. A method as claimed in any preceding claim, wherein the use of the communication service is initiated by the station.

18. A method as claimed in any preceding claim, wherein the conditions for use of the communication service are controlled by an intelligent network service.

19. A method as claimed in claim 18, wherein the intelligent network service is implemented by means of a customised applications for mobile network enhanced logic.

20. A method as claimed in any of claims 1 to 17, wherein the communication service is provided by a data network and the conditions for use of the communication service are controlled by a data network server.

21. A method as claimed in claim 20, wherein the data network comprises an internet protocol data network.

22. A method as claimed in any preceding claim, wherein the at least one condition comprises at least one of the following conditions: price for the use of the communication service; quality of service; a service restriction.

23. A communication system, comprising:
controller means for controlling provision of communication services for a station;
location information service adapted to provide information associated with the geographical location of the station; and
service controller means for controlling the provision of said communication service based on said information.

24. A communication system as claimed in claim 23, wherein the service controller means are adapted to control the communication service by setting a control parameter for the use of the communication service.

25. A communication system as claimed in claim 24, wherein the control parameter associates with the price for the use of the communication service.

26. A communication system as claimed in any of claims 23 to 25, wherein the service controller means are adapted to control the provision of communication services for the station based on a defined geographical area.

27. A communication system as claimed in any of claims 23 to 26, wherein the service controller means is adapted to set conditions for the use of the communication service substantially at the same time with a procedure for establishing a communication session for the station.

28. A communication system as claimed in any of claims 23 to 27, wherein the service controller means is adapted to set conditions for the use of the communication service during an already established communication session.

29. A communication system as claimed in any of claims 23 to 28, wherein the service controller means is adapted to request for information associated with the geographical location of the station from the location information service.

30. A communication system as claimed in any of claims 23 to 29, wherein the location information service is provided by the communication system.

31. A communication system as claimed in any of claims 23 to 30, comprising at least one element adapted to determine the geographical location of the station.

32. A communication system as claimed in any of claims 23 to 31, wherein the service controller means are provided by an intelligent network service.

33. A communication system as claimed in any of claims 23 to 31, wherein the service controller means are provided by an data network server.

34. A service controller for a communication system, comprising means for setting conditions for the use of a communication service that is provided for a station of the communication system, wherein the conditions are set based on information associated with the geographical location of the station, said information being provided by a location information service.
